(19) United States
(12) Patent Application Publication
(10) Pub. No.: US 2010/0008420 A1
(43) Pub. Date: Jan. 14, 2010

(54) METHOD AND DECODER FOR REALIZING RANDOM ACCESS IN COMPRESSED CODE STREAM USING MULTI-REFERENCE IMAGES

(75) Inventor: Yongbing Lin, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/548,902

(22) Filed: Aug. 27, 2009

Related U.S. Application Data
(63) Continuation of application No. PCT/CN2008/070340, filed on Feb. 21, 2008.

(30) Foreign Application Priority Data
Feb. 27, 2007 (CN) 200710073397.7
Jun. 8, 2007 (CN) 200710126108.5

(51) Int. Cl. H04N 7/46

(52) U.S. Cl. 375/240.15; 375/E07.25

(57) ABSTRACT

The present invention discloses a method for realizing random access in a compressed code stream using multi-reference images and a decoder. The method includes: receiving a bit stream carrying prediction reference characteristic indication information which is for respectively indicating prediction reference characteristics of forward prediction encoded image P frames and bidirectional prediction encoded image B frames, wherein the forward prediction encoded image P frames and bidirectional prediction encoded image B frames are after an intra-frame encoded image I frame; and parsing the prediction reference characteristic indication information during random access, and decoding image frames in the bit stream according to an instruction of the prediction reference characteristic indication information. The present invention also discloses a decoder including a code stream processing module and a video decoding module. The present invention has high flexibility, and may achieve compromise between encoding efficiency and random access performance according to actual requirements.

### CROSS-REFERENCE TO RELATED APPLICATIONS

This application is a continuation of International Patent Application No. PCT/CN2008070340, filed on Feb. 21, 2008, which claims priority to Chinese Patent Application Nos. 200710126108.5, filed on Jun. 8, 2007, and 200710073397.7, filed on Feb. 27, 2007. The contents of the above identified applications are incorporated by reference herein in their entireties.

### FIELD OF THE TECHNOLOGY

The present invention relates to an audio/video technology, and more particularly to a video compression encoding/decoding technology.

### BACKGROUND

In the past 20 years, video compression coding technology has developed increasingly, and new video compression coding standards also emerge continuously. At present, the video compression coding technology is developing towards higher coding compression efficiency, better network compatibility, wider application fields, and better user experience.

Video coding standards pursue higher coding compression efficiency while considering the random access performance of a compressed code stream at the same time. The random access performance means a capacity to start decoding a bit stream from uncertain point instead of a starting point of the bit stream and restore decoded images. The capacity is directly related to user experience. The random access performance is in contradiction to the coding compression efficiency, and therefore, seeking compromise and balance between the two is an important issue to be concerned for the video coding standards.

Demands of random access mainly include program channel switching, code stream switching, editing and splicing, random positioning for program playback, and fast forward/fast reverse, etc., in broadcasting services. Different services have different requirements for the random access performance. For example, for the broadcasting services, a digital video broadcasting (DVB) standard specifies that one random access point should appear in every 0.5 s, and for services such as video communication, video conference, and pay per view (PPV), the requirement for the random access performance decreases.

In order to support random access of a video compressed code stream, MPEG-2 has taken a series of measures. In the MPEG-2 standard, a grammar structure of six hierarchies is adopted, including a sequence, a group of pictures (GOP), an image, a slice, a macro block, and a block. An entry point of the random access has three hierarchies, i.e., a sequence header, a GOP header, and an I frame header (intra-frame encoded image). Repetitive sequence headers can support random access, and are mainly employed for program-level random access, like program switching. The GOP header and the I frame header cooperate with each other, and are mainly employed for random access within the sequence, such as code stream editing, splicing, random positioning for program playback, fast forward/fast reverse, and other operations.

Two flags are defined for the GOP header in the MPEG-2 standard, namely, closed_gop and broken_link.

The closed_gop is adapted to indicate prediction characteristics of a first set of B frames (bidirectional prediction encoded image) after a first I frame image closely following the GOP header. When the bit is set as 1, it means that these B frames only employ backward prediction or intra-frame coding.

The broken_link is adapted to indicate whether a connecting relation between two GOPs is broken or not. When the bit is set as 1, it means that the connecting relation between the two GOPs is broken, and the first set of B frames after the first I frame closely following the GOP header may not be correctly decoded due to lack of reference frames.

The closed_gop and the broken_link are cooperatively used to support the editing of the compressed code stream. When the code stream is edited, a decoder may be instructed to correctly decode the B frames closely following the I frame by setting the broken_link flag.

A GOP is a serial combination of encoded images, and may have a plurality of structures. A typical structure of the GOP is IBBP. In the GOP, a P frame denotes a forward prediction encoded image. An encoded image combination of IBBP is taken as an example below to illustrate functions of the flags.

In such a GOP structure of IBBP, if the B frames after the I frame have referred to the frames before the I frame, these B frames may not be decoded correctly during a random access from the I frame, and this situation may be indicated by the closed_gop in the GOP header. Similarly, if the reference frames before the I frame are edited, the B frames after the I frame may not be decoded correctly due to lack of reference frames, and this situation may be indicated by the broken_link.

In the MPEG-2 standard, a prerequisite for the GOP and I frame to support random access and editing is that an inter-frame prediction encoded image may only have one reference frame. However, in order to improve the encoding efficiency, the existing new video coding standards allow that an inter-frame encoded image has a plurality of reference frames. In the case that a P frame has a plurality of reference frames, the P frame may refer to the frames before the I frame, so that the I frame may not fulfill the functions of resynchronization, random access, and prevention from error diffusion. Thus, the GOP measure of MPEG-2 may not be used in applications with multi-reference frames.

The latest video coding standard H.264 adopts a multi-reference frame prediction technology. The standard adopts a brand new grammar structure. An instantaneous decoding refresh (IDR) image of a new image type is introduced in and combined with the I frame and recovery point supplemental enhancement information (SEI) message to support random access and editing of the compressed code stream. Once a decoder is adapted to process an IDR image, it instantaneously refreshes the buffer area of the reference images, so that all the reference images before the IDR become invalid, and decoding is started again from the IDR image. The IDR image may serve as a random access point for resynchronization and prevention from error diffusion.

As described above, the H.264 standard adopts a brand new grammar structure and introduces in the conception of parameter set to replace the grammar hierarchy of sequences and images in the MPEG-2. Besides, the H.264 standard also employs the IDR image of a new image type and the recovery point SEI message to support random access. Thereby, this new grammar structure and processing mechanism are quite different from the MPEG-2 standard, and the grammar hierarchical structure is completely different. However, the problem is that the H.264 standard may not be well adapted to an MPEG-2 system layer standard widely applied at present, and thus the processing efficiency is reduced when an H.264 compressed code stream is transmitted over an MPEG-2 system layer. In addition, the processing mechanism of random access for the H.264 standard is relatively complicated, as the IDR image of a new image type is introduced in, the recovery point SEI message is adopted, and the SEI supplemental information also contains four elements to be used cooperatively. Therefore, the processing mechanism of random access and editing is relatively complicated.

### SUMMARY

The objective of an embodiment of the present invention is to provide a method and a decoder for realizing random access, so as to solve the problem in the prior art that the processing mechanism of a decoder is complicated when multi-reference frames exist in an inter-frame prediction encoded image.

To achieve the above objective, the following technical schemes are provided in the embodiments of the present invention.

A method for realizing random access in a compressed code stream using multi-reference frames include:
receiving a bit stream carrying prediction reference characteristic indication information, the prediction reference characteristic indication information indicating prediction reference characteristics of forward prediction encoded image P frames and bidirectional prediction encoded image B frames, wherein the forward prediction encoded image P frames and bidirectional prediction encoded image B frames are after an intra-frame encoded image I frame; and
parsing the prediction reference characteristic indication information during random access, and decoding image frames in the bit stream according to an instruction of the prediction reference characteristic indication information.

An embodiment of the present invention further provides a decoder. The decoder includes a code stream parsing module and a video decoding module, in which
the code stream parsing module is adapted to receive a bit stream carrying prediction reference characteristic indication information, the prediction reference characteristic indication information indicates prediction reference characteristics of forward prediction encoded image P frames and bidirectional prediction encoded image B frames, the forward prediction encoded image P frames and bidirectional prediction encoded image B frames are after an intra-frame encoded image I frame, and the code stream parsing module is adapted to parse the prediction reference characteristic indication information during random access and instruct the video decoding module to decode the image frames of the bit stream according to the prediction reference characteristic indication information; and
the video decoding module is adapted to perform decoding according to an instruction of the prediction characteristic parsing unit.

The present invention overcomes the defects in the prior art by introducing in the prediction reference characteristic indication information, which indicates the prediction reference characteristics of the forward prediction encoded image P frames and the bidirectional prediction encoded image B frames after the I frame, respectively. Besides, the provided decoder processes the image frames according to the prediction reference characteristic indication information, thereby realizing the support to random access. The technical schemes of the present invention support random access of the compressed code stream in the case of multi-reference frames, and can be realized in a simple way. Besides, the present invention has high flexibility, and may achieve compromise between encoding efficiency and random access performance according to actual requirements.

### BRIEF DESCRIPTION OF THE DRAWINGS

FIG. 1 is a block diagram showing the structure of a decoder according to an embodiment of the present invention; and

FIG. 2 is a flow chart of random access according to an embodiment of the present invention.

### DETAILED DESCRIPTION

In an embodiments of the present invention, parameters are introduced into a group of pictures (GOP) header, an image header (including an I frame header), a sequence header, or a user-defined grammar element to respectively represent prediction reference characteristics of forward prediction encoded image P frames and bidirectional prediction encoded image B frames after an I frame, thereby realizing the support to random access. Meanwhile, the above information is cooperatively used with related identifiers, so that a decoder is instructed to perform correctly in the case of code stream editing and transmission errors.

In order to make the objectives, technical schemes, and advantages of the present invention comprehensible, reference frames at a number of two are taken as an example for illustration, and the present invention is further described in detail below in an embodiments with the accompanying drawings. It should be understood that those specific embodiments are for illustration only, instead of limiting the present invention.

In an embodiment of the present invention, two flags are employed to carry prediction reference characteristic indication information indicating the P frames and B frames after the I frame, for example, prediction characteristic parameters thereof. Thus, two flags need to be introduced first to represent prediction reference characteristics of the P frames and the B frames after the I frame respectively, so as to indicate whether the P frames and the B frames refer to the frames before the I frame. It should be noted that, the prediction characteristic parameter may be denoted by a flag or a fact whether some specific grammar element appears or not. Actually, whether a corresponding grammar element appears or not equals to the function of a flag. Flags are taken as an example for illustration below.

The two flags may be defined as follows:

closed_P_flag: represents the prediction reference characteristics of the P frames (if any).

when the value of closed_P_flag is 1, it indicates that the P frames after the I frame do not refer to the frames before the I frame.

when the value of closed_P_flag is 0, it indicates that the P frames after the I frame can refer to the frames before the I frame.

closed_B_flag: represents the prediction reference characteristics of the B frames (if any).

when the value of closed_B flag is 1, it indicates that the B frames after the I frame do not refer to the frames before the I frame.

when the value of closed_B flag is 0, it indicates that the B frames after the I frame can refer to the frames before the I frame.

When the P frames or the B frames do not appear in the structure of the code stream, the corresponding flag is set to be 1.

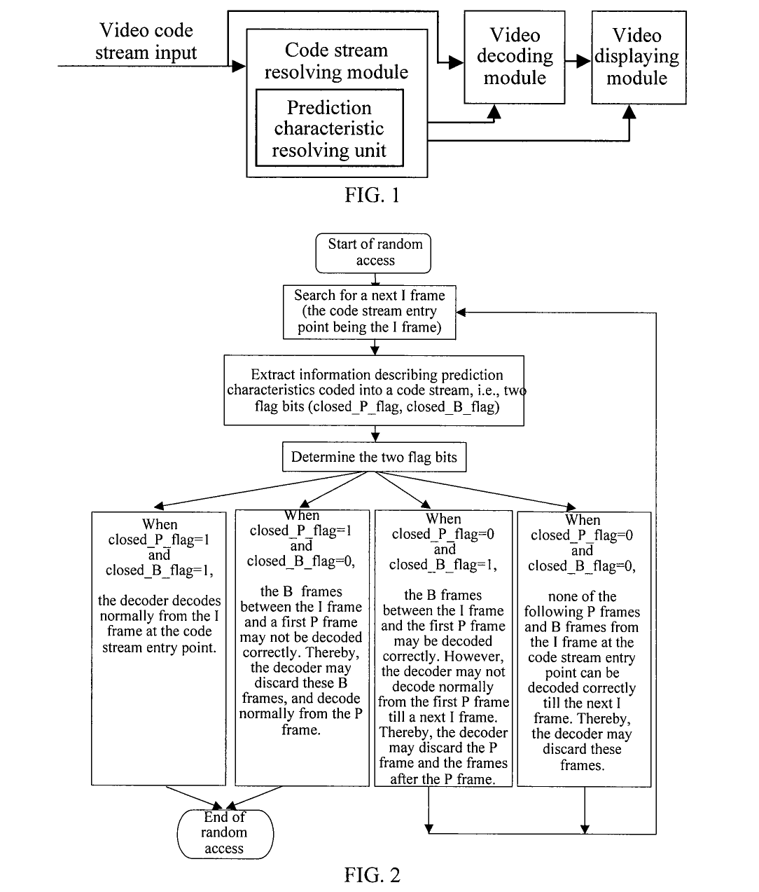

FIG. 1 is a block diagram showing the principle of a decoder provided in an embodiment of the present invention. The decoder includes a code stream parsing module, a video decoding module, and a video displaying module. The code stream parsing module includes a prediction characteristic parsing unit. When a video code stream is transmitted to the code stream parsing module and the video decoding module at the same time, the code stream parsing module receives a bit stream carrying prediction reference characteristic indication information. The prediction reference characteristic indication information respectively indicates prediction reference characteristics of forward prediction encoded image P frames and bidirectional prediction encoded image B frames. The forward prediction encoded image P frames and bidirectional prediction encoded image B frames are after an intra-frame encoded image I frame. The prediction characteristic parsing unit in the code stream parsing module parses prediction characteristic parameters indicating inter-frame encoded images carried in the code stream (the prediction reference characteristics of the P frames and the B frames), and instructs the video decoding module and the video displaying module to process image frames in the video code stream according to a parsing result. For example, the video decoding module is instructed to decode the image frames in the bit stream that can be decoded, or to discard the image frames that cannot be decoded according to the prediction characteristics thereof or insert other image frames.

Specific implementations are provided as follows.

(1) When the two flags in the bit stream are set as closed_P_flag=1 and closed_B_flag=1, it is parsed by the prediction characteristic parsing unit that, the prediction reference characteristics of the inter-frame encoded images indicate that the decoder can decode all the frames after the I frame normally. Thereby, the decoder decodes normally from the I frame at the code stream entry point.

(2) When the two flags in the bit stream are set as closed_P_flag=1 and closed_B_flag=0, it is parsed by the prediction characteristic parsing unit that, the prediction reference characteristics of the inter-frame encoded images indicate that the continuous B frames between the I frame and a first P frame after the I frame may not be decoded correctly. Thereby, the decoder discards these B frames, and decodes normally from the first P frame.

(3) When the two flags in the bit stream are set as closed_P_flag=0 and closed_B_flag=1, it is parsed by the prediction characteristic parsing unit that, the prediction reference characteristics of the inter-frame encoded images indicate that the continuous B frames between the I frame and a first P frame after the I frame may be decoded correctly. However, the decoder may not decode normally from the first P frame closely following the I frame till a next I frame. Thereby, the decoder decodes the continuous B frames between the I frame and the first P frame after the I frame, discards the P frame as well as all the P frames and B frames after the P frame, and searches for the next I frame.

(4) When the two flags in the bit stream are set as closed_P_flag=0 and closed_B_flag=0, it is parsed by the prediction characteristic parsing unit that, the prediction reference characteristics of inter-frame encoded image indicate that none of the P frames and B frames after the I frame at the code stream entry point till a next I frame may be decoded correctly. Thereby, the decoder may discard all the B frames and P frames after the I frame, and searches for the next I frame.

In practice, the prediction characteristic parsing unit may consist of a parsing unit, a first processing unit, and a second processing unit.

The parsing unit is adapted to parse the prediction characteristic parameters in the bit stream.

The first processing unit is adapted to process the image frames that cannot be decoded as parsed by the parsing unit according to the prediction characteristic parameters, and instruct the video decoding module to discard the image frames that cannot be decoded as indicated by the prediction characteristics or to insert other image frames.

The second processing unit is adapted to instruct the video decoding module to decode the image frames that can be decoded as parsed by the parsing unit according to the prediction characteristic parameters.

The prediction characteristic parameters indicating the inter-frame encoded images may be coded into an image header, a GOP header, a sequence header, or a user-defined grammar element. The image header includes an I frame header. Four embodiments are described below.

Embodiment 1: The prediction characteristic parameters indicating the inter-frame encoded images are coded into the I frame header.

Two flags are introduced into the I frame header, respectively indicating whether P frames and B frames after an I frame refer to the frames before the I frame or not. If none of the B frames or P frames exists in the code stream, these fields may not be explained.

When random access of a code stream is realized, the above two flags are adopted to indicate prediction reference characteristics of inter-frame encoded images of a decoder. Two circumstances are illustrated as follows.

(1) When the value of closed_P_flag is 1, it indicates that the P frames after the I frame do not refer to the frames before the I frame, and the decoder may decode the P frames correctly. The following B frames may be processed in the following two cases:

when the value of closed_B_flag is 1, it indicates that the B frames do not refer to the frames before the I frame. At this point, the decoder may also decode the B frames correctly, and the decoder begins to decode from the I frame; and

when the value of closed_B_flag=0, it indicates that the B frames can refer to the frames before the I frame. All the continuous B frames between the I frame and a first P frame after the I frame may not be decoded correctly and all the frames following the P frame may be decoded correctly. Thereby, the decoder may discard all the continuous B frames between the I frame and the first P frame.

(2) When the value of closed_P_flag is 0, it indicates that the P frames can refer to the frames before the I frame. If the P frames refer to the frames before the I frame, the P frames may not be decoded correctly due to lack of reference frames. The following B frames may be processed in the following two cases:

when the value of closed_B_flag is 1, it indicates that the B frames do not refer to the frames before the I frame. At this point, the decoder may decode correctly all the continuous B frames between the I frame and a first P frame after the I frame, but may not decode correctly the frames after the first P frame closely following the I frame. Thereby, the decoder may discard the first P frame closely following the I frame and all the P frames and B frames after the first P frame till a next I frame in the code stream.

when the value of closed_B flag is 0, it indicates that the B frames can refer to the frames before the I frame. If the B frames refer to the frames before the I frame, the B frames may not be decoded due to lack of reference frames, and the P frames and B frames after the I frame at the code stream entry point may not be decoded correctly. Thereby, the decoder may discard all the P frames and B frames after the I frame till a next I frame.

FIG. 2 is a flow chart of random access, which includes the following steps.

1. A random access starts.

2. A decoder searches for a next I frame.

3. The decoder extracts prediction characteristic parameters coded in a code stream. The parameters indicate P frames and B frames after an I frame, i.e., two flags, namely, closed_P_flag and closed_B_flag.

4. The decoder performs processing according to the two flags as follows.

(1) When the value of closed_P flag is 1 and the value of closed_B_flag is 1, the decoder decodes normally from the I frame at a code stream entry point, and Step 5 is performed. When the value of closed_P_flag is 1 and the value of closed_B_flag is 0, the continuous B frames between the I frame and a first P frame may not be decoded correctly. Thereby, the decoder discards these B frames, and decodes normally from the P frame. Step 5 is then performed.

(2) When the value of closed_P flag is 0 and the value of closed_B_flag is 1, the continuous B frames between the I frame and a first P frame may be decoded correctly. However, the decoder may not decode normally from the first P frame closely following the I frame till a next I frame. Thereby, the decoder decodes the continuous B frames between the I frame and the first P frame, and discards the first P frame as well as all the P frames and B frames after the first P frame. Step 2 is then performed. When the value of closed_P_flag is 0 and the value of closed_B flag is 0, the P frames and B frames after the I frame at the code stream entry point till a next I frame may not be decoded correctly, and thus the decoder may discard all the B frames and P frames after the I frame. Step 2 is then performed.

5. The random access ends.

It should be noted that, after determining prediction reference characteristics of the P frames and B frames after the I frame according to the flags, the decoder may discard the frames that cannot be decoded, display other pictures, or employ a refresh technology. In the present invention, that the decoder discards the frames that cannot be decoded is taken as an example for illustration. However, in practice, the present invention is not limited to the technical scheme of simply discarding the frames.

As described above in the background, demands of random access mainly includes program channel switching, code stream switching, editing and splicing, random positioning for program playback, and fast forward/fast reverse, etc., in broadcasting services. Applications of the technical schemes provided in the embodiment of the present invention are given below in the case of code stream editing and transmission packet loss. These applications are also suitable for other embodiments of the present invention.

1. The flags and editing identifiers are used cooperatively, which is suitable for applications of code stream editing.

When a code stream is edited, the prediction characteristic parameters indicating the inter-frame encoded images cooperate with the editing identifiers. For example, a particular start code may be used as an editing identifier to support the code stream editing. When the code stream is edited, the editing identifier may be inserted at an editing point. Specific implementations are provided as follows.

When the value of closed_P_flag is 1 and the value of closed_B_flag is 1, it indicates that none of the following P frames and B frames refers to the frames before the I frame. At this point, the editing identifier does not need to be inserted. Thus, in decoding, the decoder does not read and find the editing identifier, and decodes normally from the I frame.

When the value of closed_P_flag is 1 the value of and closed_B_flag is 0, it indicates that only the B frames can refer to the frames before the I frame. At this point, the editing identifier is inserted at the editing point, which means that all the continuous B frames between the I frame and a first P frame after the I frame may not be decoded due to lack of reference frames. Thus, in decoding if the decoder reads and finds the editing identifier, the decoder may discard these B frames, and then decodes normally from the first P frame.

When the value of closed_P_flag is 0 and the value of closed_B_flag is 1, it indicates that only the P frames can refer to the frames before the I frame. At this point, the editing identifier is inserted, which means that the P frame closely following the I frame and all the P frames and B frames after the P frame may not be decoded due to lack of reference frames. Thus, in decoding if the decoder reads and finds the editing identifier, the decoder may discard these frames till a next I frame. However, the continuous B frames between the I frame and the first P frame after the I frame may be decoded correctly.

When the value of closed_P_flag is 0 and the value of closed_B_flag is =0, it indicates that all the P frames and B frames can refer to the frames before the I frame. At this point, the editing identifier is inserted, which means that the following P frames and B frames may not be decoded due to lack of reference frames. Thus, in decoding, the decoder reads and finds the editing identifier, and may not decode from the first frame after the I frame till a next I frame. Then, the decoder discards these frames.

It should be noted that, after determining that a certain position is edited according to the editing identifier, and determining the prediction reference characteristics of the P frames and B frames after the I frame through the flags, the decoder may discard the frames that cannot be decoded, insert other predetermined image frames, or employ a refresh technology. In the present invention, that the decoder discards the frames that cannot be decoded is taken as an example for illustration. However, in practice, the present invention is not limited to the technical scheme of simply discarding the frames.

2. The flags and a transmission error identifier are used cooperatively, which is suitable for applications of transmission packet loss.

During the transmission process if packet loss occurs to reference frames before the I frame, a transmission error identifier bit is set as 1. At this point, the transmission error identifier (indicated by a system layer) is used cooperatively with the information to correctly instruct the decoder to handle the situation of packet loss, so as to avoid decoding or displaying those images that cannot be decoded correctly due to lack of reference frames.

The above process is similar to that of the editing identifier. In particular, when the transmission error identifier bit is set as 1 (denoting that packet loss or transmission error occurs to the reference frames before the I frame), the following circumstances may be resulted.

When the value of closed_P flag is 1 and the value of closed_B_flag is 1, it indicates that none of the following P frames and B frames refers to the frames before the I frame. At this point, the decoder decodes normally from the I frame.

When the value of closed_P_flag is 1 and the value of closed_B_flag is 0, it indicates that only the B frames can refer to the frames before the I frame, which means that the continuous B frames between the I frame and a first P frame after the I frame may not be decoded due to lack of reference frames. Thereby, the decoder discards these B frames, and decodes normally from the first P frame.

When the value of closed_P_flag is 0 and the value of closed_B_flag is 1, it indicates that only the P frames can refer to the frames before the I frame, and the B frames between the I frame and the first P frame after the I frame may still be decoded correctly. The decoder may not decode the frames from the first P frame closely following the I frame, and thus may discard the first P frame and all the P frames and B frames after the first P frame till a next I frame;

When the value of closed_P_flag is 0 and the value of closed_B_flag is 0, it indicates that the P frames and B frames can both refer to the frames before the I frame. At this point, none of the P frames and B frames may be decoded due to lack of reference frames. The decoder may not decode the frames from the first frame following the I frame till a next random access point, and thus discards these frames.

In this embodiment, prediction characteristic parameters indicating the inter-frame encoded images are coded into an I frame header, so as to support random access. These parameters used cooperatively with the editing identifier and the transmission error identifier may also be suitable for applications of code stream editing and transmission errors, so that the grammar hierarchy of GOP is not needed. Thereby, the grammar structure is simplified, and the bit number required for coding the GOP is reduced.

### Embodiment 2

The prediction characteristic parameters indicating inter-frame encoded images are coded into a GOP header.

First, the two flags closed_P_flag and closed_B_flag need to be introduced into an MPEG-2 GOP to replace an original closed_gop flag in the MPEG-2 GOP. The meaning of broken_link is redefined to accommodate applications with multi-reference frames.

1) A new GOP header is redefined as follows.

GOP_header
{
time_code
closed_P_flag
closed_B_flag
broken_link
}

in which, time_code still adopting the original definition in the MPEG-2 GOP, is mainly applied in a video tape recorder, and is not used in the decoding process.

2) The meaning of a broken_link flag is redefined as follows.

the broken_link is adapted to assist editing with a default value 0. When broken_link is set to be 1, a connecting relation between adjacent two GOPs is broken. For a compressed code stream that is edited, the flag is used cooperatively with prediction characteristic information representing the P frames and B frames to instruct the decoder on how to correctly process the P frames and B frames after the I frame. During the editing, operations on broken_link are as follows:

When the value of closed_P_flag is 1 and the value of closed_B_flag is 1, it indicates that none of the following P frames and B frames refers to the frames before the I frame. Thereby, broken_link remains unchanged and is still set to be 0, which means that the following P frames and B frames may be decoded correctly.

When the value of closed_P_flag is 1 and the value of closed_B_flag is 0, it indicates that only the B frames can refer to the frames before the I frame. At this point, broken link is set to be 1, which means that the following B frames (the B frames closely following the I frame and between the I frame and a first P frame in the coding sequence) may not be decoded correctly due to lack of reference frames.

When the value of closed_P_flag is 0 and the value of closed_B_flag is 1, it indicates that only the P frames can refer to the frames before the I frame. At this point, broken_link is set to be 1, which means that the following P frames and the P frames and B frames after the P frames may not be decoded correctly due to lack of reference frames and the following B frames (the B frames closely following the I frame and between the I frame and the first P frame in the coding sequence) may still be decoded correctly.

When the value of closed_P_flag is 0 and the value of closed_B_flag is 0, it indicates that the P frames and B frames both refer to the frames before the I frame. At this point, broken_link is set to be 1, which means that the following P frames and B frames may not be decoded correctly due to lack of reference frames.

In this embodiment, the working principles of the prediction characteristic parameters indicating the inter-frame encoded images coded into the GOP header in the applications of random access and transmission errors are the same as those in the Embodiment 1. During the editing of the code stream, the support to the editing of the code stream may be realized directly through three parameters, namely, closed_P_flag, closed_B_flag, and broken_link. An editing identifier does not need to be inserted. Specific implementations are described as follows.

When the value of closed_P_flag is 1 and the value of closed_B_flag is 1, it indicates that none of the following P frames and B frames refers to the frames before the I frame. Thereby, broken_link remains unchanged and is still set to be 0, which means that the following P frames and B frames may be decoded correctly as far as the decoder. The decoder begins to decode from the I frame.

When the value of closed_P_flag is 1 and the value of closed_B_flag is 0, it indicates that only the B frames refer to the frames before the I frame. At this point, broken_link is set to be 1, which means that the following B frames (the B frames closely following the I frame and between the I frame and the first P frame in the coding sequence) may not be decoded correctly due to lack of reference frames. The decoder may discard these B frames.

When the value of closed_P_flag is 0 and the value of closed_B_flag is 1, it indicates that only the P frames refer to the frames before the I frame. At this point, broken_link is set to be 1, which means that the following P frames and the P frames and B frames after the P frames may not be decoded correctly due to lack of reference frames and the following B frames (the B frames closely following the I frame and between the I frame and the first P frame in the coding sequence) may still be decoded correctly. The decoder discards the first P frame closely following the I frame and the P frames and B frames after the first P frame till a next I frame.

When the value of closed_P_flag is 0 and the value of closed_B_flag is 0, it indicates that the P frames and B frames both refer to the frames before the I frame. At this point, broken_link is set to be 1, which means that the following P frames and B frames may not be decoded correctly due to lack of reference frames. The decoder may not decode from the first frame following the I frame till a next random access point, and thus discards these frames.

After determining prediction reference characteristics of the P frames and B frames after the I frame according to broken_link, closed_P_flag, and closed_B_flag, the decoder may discard the frames that cannot be decoded, insert other predetermined image frames, or employ a refresh technology. In the present invention, that the decoder discards the frames that cannot be decoded is taken as an example for illustration. However, in practice, the present invention is not limited to the technical scheme of simply discarding the frames.

### Embodiment 3

The prediction reference characteristic parameters are respectively carried in specific grammar elements and prediction encoded image headers.

The prediction reference characteristic parameters indicating the inter-frame encoded images P are carried in specific grammar elements. Whether these specific grammar elements appear or not indicates whether the P frames after the I frame refer to the frames before the I frame or not. These specific grammar elements need to be placed before the I frame, and include a GOP header, a sequence header, or a user-defined header. The user-defined header need to start with a startcode, and the content thereof may be set as null.

The prediction reference characteristic parameters indicating the inter-frame encoded images B are carried in B frame image headers. In the B frame headers, a flag closed_B_flag is introduced, indicating whether the B frames after the I frame refer to the frames before the I frame or not. If the B frames or P frames do not exist in a code stream, these fields may not be explained.

During the random access, the above information is adopted by the decoder to parse the prediction reference characteristics of the inter-frame encoded images. Specific implementations are illustrated in the following two cases.

(1) When the specific grammar elements appear before the I frame, it is indicated that the P frames after the I frame do not refer to the frames before the I frame. The decoder may decode the P frames correctly. The following B frames may be processed in the following two cases.

When the value of closed_B_flag is 1, it indicates that the following B frames do not refer to the frames before the I frame. At this point, the decoder may also decode the B frames correctly. The decoder decodes correctly from the I frame.

When the value of closed_B_flag is 0, it indicates that the B frames can refer to the frames before the I frame. All the continuous B frames between the I frame and a first P frame after the I frame may not be decoded correctly and all the following frames from the P frame may be decoded correctly. Thereby, the decoder discards all the continuous B frames between the I frame and the first P frame.

(2) When the specific grammar elements do not appear before the I frame, it is indicated that the P frames can refer to the frames before the I frame. At this point, the P frames may not be decoded correctly due to lack of reference frames. The following B frames may be processed in the following two cases.

When the value of closed_B_flag is 1, it indicates that the B frames do not refer to the frames before the I frame. At this point, the decoder may decode all the continuous B frames between the I frame and the first P frame after the I frame correctly, but may not decode from the first P frame closely following the I frame correctly. Thereby, the decoder may discard the first P frame closely following the I frame and all the P frames and B frames after the first P frame till a next I frame in the code stream.

When the value of closed_B_flag is 0, it indicates that the B frames can refer to the frames before the I frame. At this point, the B frames may not be decoded correctly due to lack of reference frames. None of the following P frames and B frames from the I frame at the code stream entry point can be decoded correctly. Thereby, the decoder may discard all the P frames and B frames after the I frame till a next I frame.

It should be noted that, after determining prediction reference characteristics of the P frames and B frames after the I frame, the decoder may discard the frames that cannot be decoded, display other pictures, or employ a refresh technology. In the present invention, that the decoder discards the frames that cannot be decoded is taken as an example for illustration. However, in practice, the present invention is not limited to the technical scheme of simply discarding the frames.

### Embodiment 4

The prediction reference characteristic parameters are carried in specific grammar elements.

Two user-defined grammar elements AA and BB indicate prediction reference characteristic parameters of inter-frame encoded images P and B, respectively. Whether these specific grammar elements appear or not indicates whether the P or B frames following the I frame refer to the frames before the I frame or not. These specific grammar elements AA and BB are placed before the I frame, and may be a GOP header, a sequence header, or a user-defined header. The user-defined header starts with a startcode, and the content thereof may be set as null.

During the random access, the above information is adopted by the decoder to parse the prediction reference characteristics of the inter-frame encoded images. Specific implementations are illustrated in the following two cases.

(1) When the specific grammar element AA appears before the I frame, it is indicated that the P frames after the I frame do not refer to the frames before the I frame. The decoder may decode the P frames correctly. The following B frames may be processed in the following two cases.

When the specific grammar element BB appears, it is indicated that the following B frames do not refer to the frames before the I frame. At this point, the decoder may also decode the B frames correctly. The decoder decodes correctly from the I frame.

When the specific grammar element BB does not appear, it is indicated that the B frames refer to the frames before the I frame. All the continuous B frames between the I frame and the first P frame after the I frame may not be decoded correctly and all the following frames from the P frame may be decoded correctly. Thereby, the decoder discards all the continuous B frames between the I frame and the first P frame.

(2) When the specific grammar element AA does not appear before the I frame, it is indicated that the P frames can refer to the frames before the I frame. At this point, the P frames may not be decoded correctly due to lack of reference frames. The following B frames may be processed in the following two cases.

When the specific grammar element BB appears, it is indicated that the B frames do not refer to the frames before the I frame. At this point, the decoder may decode all the continuous B frames between the I frame and the first P frame after the I frame correctly, but may not decode from the first P frame closely following the I frame correctly. Thereby, the decoder may discard the first P frame closely following the I frame and all the P frames and B frames after the first P frame till a next I frame in the code stream.

When the specific grammar element BB does not appear, it is indicated that the B frames can refer to the frames before the I frame. At this point, the B frames may not be decoded correctly due to lack of reference frames. None of the following P frames and B frames from the I frame at the code stream entry point can be decoded correctly. Thereby, the decoder may discard all the P frames and B frames after the I frame till a next I frame.

It should be noted that, after determining prediction reference characteristics of the P frames and B frames after the I frame, the decoder may discard the frames that cannot be decoded, display other pictures, or employ a refresh technology. In the present invention, that the decoder discards the frames that cannot be decoded is taken as an example for illustration. However, in practice, the present invention is not limited to the technical scheme of simply discarding the frames.

In view of the above, in the technical schemes provided in the embodiments of the present invention, parameters are introduced into the image header, GOP header, sequence header, or user-defined specific grammar element, which indicate the prediction reference characteristics of the P frames and B frames after the I frame respectively. The decoder processes the image frames according to the prediction reference characteristics, thereby realizing the support to random access. Meanwhile, the above information is used cooperatively with related identifiers, so that the decoder is instructed to perform correctly. Therefore, the present invention supports random access of the compressed code in the case of multi-reference frames, and is applicable to circumstances of the editing of the compressed code stream and transmission packet loss of the code stream. Besides, the technical schemes provided in the embodiments of the present invention may be realized in a simple way, have high flexibility, and may achieve compromise between encoding efficiency and random access performance according to various application circumstances.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for realizing random access in a compressed code stream using multi-reference frames, comprising:
receiving a bit stream carrying prediction reference characteristic indication information, wherein the prediction reference characteristic indication information indicates prediction reference characteristics of forward prediction encoded image P frames and bidirectional prediction encoded image B frames, and the forward prediction encoded image P frames and bidirectional prediction encoded image B frames are after an intra-frame encoded image I frame; and
parsing the prediction reference characteristic indication information during random access, and decoding image frames in the bit stream according to an instruction of the prediction reference characteristic indication information.

2. The method according to claim 1, wherein the prediction reference characteristic indication information is a flag in a group of pictures (GOP) header, a flag in an image header, a flag in a sequence header, or a flag in a user-defined grammar element.

3. The method according to claim 1, wherein the prediction reference characteristic indication information indicates the prediction reference characteristics of the forward prediction encoded image P frames and the bidirectional prediction encoded image B frames by means of judging whether a specific grammar element appears or not, the forward prediction encoded image P frames and bidirectional prediction encoded image B frames are after the intra-frame encoded image I frame, and the specific grammar element comprises an image header, a GOP header, a sequence header, or a user-defined grammar element.

4. The method according to claim 1, wherein the prediction reference characteristic indication information specifically indicates that the P frames and B frames do or do not refer to the image frames before the I frame in the bit stream.

5. The method according to claim 4, wherein the decoding the image frames in the bit stream according to the instruction of the prediction reference characteristic indication information comprises:
beginning to decode from the I frame if the prediction reference characteristic indication information indicates that none of the P frames and B frames after the I frame refers to the frames before the I frame.

6. The method according to claim 4, wherein the decoding the image frames in the bit stream according to the instruction of the prediction reference characteristic indication information comprises:
discarding the P frames and B frames after the I frame till a next I frame in the bit stream or inserting other predetermined image frames till a next I frame in the bit stream, if the prediction reference characteristic indication information indicates that the P frames and B frames after the I frame can refer to the frames before the I frame.

7. The method according to claim 4, wherein the decoding the image frames in the bit stream according to the instruction of the prediction reference characteristic indication information comprises:
decoding the continuous B frames positioned between the I frame and a first P frame after the I frame, and discarding the first P frame as well as the P frames and B frames after the first P frame till a next I frame in the bit stream or inserting other image frames till a next I frame in the bit stream, if the prediction reference characteristic indication information indicates that the P frames after the I frame can refer to the frames before the I frame and the B frames after the I frame do not refer to the frames before the I frame.

8. The method according to claim 4, wherein the decoding the image frames in the bit stream according to the instruction of the prediction reference characteristic indication information comprises:
beginning to decode from the I frame, discarding the continuous B frames between the I frame and a first P frame after the I frame or inserting other image frames, and then beginning to decode from the first P frame after the I frame, if the prediction reference characteristic indication information indicates that the P frames after the I frame do not refer to the frames before the I frame and the B frames after the I frame can refer to the frames before the I frame.

9. The method according to claim 4, wherein when the bit stream is edited,
no editing identifier is inserted at an editing point if the prediction reference characteristic indication information indicates that none of the P frames and B frames after the I frame refers to the frames before the I frame, and the decoding the image frames in the bit stream according to the prediction reference characteristic indication information comprises: beginning to decode from the I frame.

10. The method according to claim 4, wherein when the bit stream is edited,
an editing identifier is inserted at an editing point if the prediction reference characteristic indication information indicates that the P frames and B frames after the I frame can refer to the frames before the I frame, and the decoding the image frames in the bit stream according to the prediction reference characteristic indication information comprises: discarding the P frames and B frames after the I frame till a next I frame in the bit stream or inserting other image frames till a next I frame in the bit stream.

11. The method according to claim 4, wherein when the bit stream is edited,
an editing identifier is inserted at an editing point if the prediction reference characteristic indication information indicates that the P frames after the I frame can refer to the frames before the I frame and the B frames after the I frame do not refer to the frames before the I frame, and the decoding the image frames in the bit stream according to the prediction reference characteristic indication information comprises: decoding the continuous B frames between the I frame and a first P frame after the I frame, and discarding the first P frame as well as the P frames and B frames after the first P frame till a next I frame in the bit stream or inserting other predetermined image frames till a next I frame in the bit stream.

12. The method according to claim 4, wherein when the bit stream is edited,
an editing identifier is inserted at an editing point if the prediction reference characteristic indication information represents that the P frames after the I frame do not refer to the frames before the I frame and the B frames after the I frame can refer to the frames before the I frame, and the decoding the image frames in the bit stream according to the prediction reference characteristic indication information comprises: beginning to decode from the I frame, discarding the continuous B frames between the I frame and a first P frame after the I frame or inserting other predetermined image frames, and then beginning to decode from the first P frame after the I frame.

13. The method according to claim 4, wherein when the bit stream is edited,
a flag broken_link in the GOP header is set to be 0, if the prediction reference characteristic indication information indicates that none of the P frames and B frames after the I frame refers to the frames before the I frame, and the decoding the image frames in the bit stream according to the prediction reference characteristic indication information comprises: beginning to decode from the I frame.

14. The method according to claim 4, wherein when the bit stream is edited,
a flag broken_link in the GOP header is set to be 1, if the prediction reference characteristic indication information indicates that the P frames and B frames after the I frame can refer to the frames before the I frame, and the decoding the image frames in the bit stream according to the prediction reference characteristic indication information comprises: discarding the P frames and B frames after the I frame till a next I frame in the bit stream or inserting other image frames till a next I frame in the bit stream.

15. The method according to claim 4, wherein when the bit stream is edited,
a flag broken_link in the GOP header is set to be 1, if the prediction reference characteristic indication information indicates that the P frames after the I frame can refer to the frames before the I frame and the B frames after the I frame do not refer to the frames before the I frame, and the decoding the image frames in the bit stream according to the prediction reference characteristic indication information comprises: decoding the continuous B frames between the I frame and a first P frame after the I frame, and discarding the first P frame as well as the P frames and B frames after the first P frame till a next I frame in the bit stream or inserting other image frames till a next I frame in the bit stream.

16. The method according to claim 4, wherein when the bit stream is edited,
a flag broken_link in the GOP header is set to be 1, if the prediction reference characteristic indication information represents that the P frames after the I frame do not refer to the frames before the I frame and the B frames after the I frame can refer to the frames before the I frame, and the decoding the image frames in the bit stream according to the prediction reference characteristic indication information comprises: beginning to decode from the I frame, discarding the continuous B frames between the I frame and a first P frame after the I frame or inserting other predetermined image frames, and then beginning to decode from the first P frame after the I frame.

17. The method according to claim 4, wherein
a transmission error identifier is set to be 1 when packet loss occurs to reference frames before the I frame in the bit stream; and
the decoding the image frames in the bit stream according to the prediction reference characteristic indication information comprises: when the transmission error identifier is set to be 1,
beginning to decode from the I frame, if the prediction reference characteristic indication information indicates that none of the P frames and B frames after the I frame refers to the frames before the I frame; or
discarding the P frames and B frames after the I frame till a next I frame in the bit stream or inserting other image frames till a next I frame in the bit stream, if the prediction reference characteristic indication information indicates that the P frames and B frames after the I frame refer to the frames before the I frame; or
decoding the continuous B frames between the I frame and a first P frame after the I frame, and discarding the first P frame as well as the P frames and B frames after the first P frame till a next I frame in the bit stream or inserting other image frames till a next I frame in the bit stream, if the prediction reference characteristic indication information indicates that P frames after the I frame can refer to the frames before the I frame and the B frames after the I frame do not refer to the frames before the I frame; or
beginning to decode from the I frame, discarding the continuous B frames between the I frame and the first P frame after the I frame or inserting other predetermined image frames, and then beginning to decode from the first P frame after the I frame, if the prediction reference characteristic indication information indicates that the P frames after the I frame do not refer to the frames before the I frame and the B frames after the I frame can refer to the frames before the I frame.

18. A decoder, comprising a code stream parsing module and a video decoding module, wherein
the code stream parsing module is adapted to receive a bit stream carrying prediction reference characteristic indication information, the prediction reference characteristic indication information indicates prediction reference characteristics of forward prediction encoded image P frames and bidirectional prediction encoded image B frames, the forward prediction encoded image P frames and bidirectional prediction encoded image B frames are after an intra-frame encoded image I frame, and the code stream parsing module is adapted to parse the prediction reference characteristic indication information during random access and instruct the video decoding module to decode the image frames of the bit stream according to the prediction reference characteristic indication information; and
the video decoding module is adapted to perform decoding according to an instruction of the prediction characteristic parsing unit.

19. The decoder according to claim 18, wherein the prediction reference characteristic indication information is a flag in a group of pictures (GOP) header, a flag in an image header, a flag in a sequence header, or a flag in a user-defined grammar element.

20. The decoder according to claim 18, wherein the prediction reference characteristic indication information indicates the prediction reference characteristics of the forward prediction encoded image P frames and the bidirectional prediction encoded image B frames by means of detecting whether a specific grammar element appears or not, the forward prediction encoded image P frames and bidirectional prediction encoded image B frames are after the intra-frame encoded image I frame, and the specific grammar element comprises an image header, a GOP header, a sequence header, or a user-defined grammar element.
